(19) United States
(12) Patent Application Publication
(10) Pub. No.: US 2016/0060548 A1
(43) Pub. Date: Mar. 3, 2016

(54) METHODS AND APPARATUSES FOR HYDROPROCESSING HYDROCARBONS

(71) Applicant: UOP LLC, Des Plaines, IL (US)

(72) Inventors: Aleksey Y. Pelekh, Woodridge, IL (US); John E. Kulach, Chicago, IL (US)

(21) Appl. No.: 14/473,108

(22) Filed: Aug. 29, 2014

(51) Int. Cl. C10G 65/12; B01J 19/24; C10G 45/12

(52) U.S. Cl. CPC C10G 65/12; C10G 45/12; B01J 19/245; B01J 2219/24

(57) ABSTRACT

Methods and apparatuses for hydroprocessing a hydrocarbon stream are provided herein. In an embodiment, a method of hydroprocessing the hydrocarbon stream includes hydrocracking the hydrocarbon stream in a first hydrocracking stage in the presence of a first hydrocracking catalyst to produce a first conversion stream. Components from the first conversion stream are treated in a downstream processing stage in the presence of a downstream resid hydrotreating catalyst to produce a second conversion stream.

### TECHNICAL FIELD

The technical field generally relates to methods and apparatuses for hydroprocessing hydrocarbons and, more particularly, relates to methods and apparatuses for treating polynuclear aromatic compounds in hydrocarbon streams.

### BACKGROUND

Petroleum refiners often produce hydrocarbon products, such as turbine fuel, diesel fuel, middle distillates, and gasoline boiling hydrocarbons among others by hydroprocessing a hydrocarbon stream derived from crude oil or fractions thereof. Hydrocarbon streams that are often subjected to hydroprocessing include vacuum gas oils, heavy gas oils, and other hydrocarbon streams recovered from crude oil by distillation. For example, a typical heavy gas oil includes a substantial portion of hydrocarbon components that boil above about 371° C., and generally at least about 50 weight % of the hydrocarbon components in the heavy gas oil boil above 371° C. A typical vacuum gas oil generally has a boiling point range of from about 315° C. to about 565° C.

Conventional hydroprocessing techniques can include, for example, hydrocracking, hydrotreating, hydroisomerization, hydrodesulfurization, and the like. Gasoline boiling hydrocarbons and middle distillates, in particular, are often produced by catalytically hydrocracking the hydrocarbon stream, such as vacuum gas oil, into product hydrocarbons of lower average molecular weight and boiling point. Hydrocracking is often conducted by contacting, in an appropriate vessel, the hydrocarbon stream with a suitable hydrocracking catalyst under appropriate conditions. These conditions generally include elevated temperature and elevated pressure in the presence of hydrogen. Desired hydrocarbon products often boil in a range of from about 85° C. to about 215° C. or in a range of from about 150° C. to about 425° C.

Hydroprocessing techniques, most notably hydrocracking, often produce problematic compounds known as heavy polynuclear aromatics (HPNAs). Polynuclear aromatics (PNA) are compounds that have two or more aromatic rings. HPNAs generally refer to compounds with six or more aromatic rings and often refer to compounds with eleven or more aromatic rings. HPNAs can cause a host of processing difficulties. For example, the HPNAs may build up in a hydroprocessing recycle loop and accelerate catalyst deactivation through coke formation on the catalyst. HPNAs may also deposit within various downstream units, such as heat exchangers, resulting in process shutdown for cleaning.

Various approaches have been taken to address HPNA buildup in apparatuses that are employed for hydrocracking. For example, various fractionation techniques have been employed to separate the HNPAs from desired products. However, such fractionation techniques often represent substantial additional capital and operating costs. Further, the separated HPNAs represent a waste stream and result in loss of desired product yield from the hydrocarbon stream.

Accordingly, it is desirable to provide methods and apparatuses for hydrocracking a hydrocarbon stream that more effectively crack HPNAs formed during hydrocracking to minimize the impact of the HPNAs on hydroprocessing dynamics. Furthermore, other desirable features and characteristics of the present invention will become apparent from the subsequent detailed description and the appended claims, taken in conjunction with the accompanying drawings and this background.

### BRIEF SUMMARY

Methods and apparatuses for hydroprocessing a hydrocarbon stream are provided herein. In an embodiment, a method of hydroprocessing the hydrocarbon stream includes hydrocracking the hydrocarbon stream in a first hydrocracking stage in the presence of a first hydrocracking catalyst to produce a first conversion stream. Components from the first conversion stream are treated in a downstream processing stage in the presence of a downstream resid hydrotreating catalyst to produce a second conversion stream.

In another embodiment, a method of hydroprocessing a hydrocarbon stream includes providing the hydrocarbon stream depleted of metal-containing species. The metal-depleted hydrocarbon stream is treated in a hydroprocessing stage in the presence of a resid hydrotreating catalyst to produce a conversion stream.

In another embodiment, an apparatus for hydroprocessing a hydrocarbon stream is provided. The apparatus includes an initial hydrocracking bed that includes a first hydrocracking catalyst for hydrocracking the hydrocarbon stream to produce a first conversion stream. A downstream bed includes a downstream resid hydrotreating catalyst for treating the components from the first conversion stream to produce a second conversion stream.

### BRIEF DESCRIPTION OF THE DRAWINGS

The various embodiments will hereinafter be described in conjunction with the following drawing figures, wherein like numerals denote like elements, and wherein:

FIG. 1 is a schematic diagram of an apparatus and a method for hydroprocessing a hydrocarbon stream in accordance with an exemplary embodiment;

FIG. 2 is a schematic diagram of another apparatus and a method for hydroprocessing a hydrocarbon stream in accordance with another exemplary embodiment;

FIG. 3 is a schematic diagram of another apparatus and a method for hydroprocessing a hydrocarbon stream in accordance with another exemplary embodiment; and

FIG. 4 is a schematic diagram of another apparatus and a method for hydroprocessing a hydrocarbon stream in accordance with another exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Methods and apparatuses for hydroprocessing a hydrocarbon stream are provided herein. The methods and apparatuses employ a resid hydrotreating catalyst for saturating polynuclear aromatic compounds, such as heavy polynuclear aromatic compounds (HPNAs), that are produced during hydrocracking. Resid hydrotreating catalysts are hydrotreating catalysts that have a nominal average minimum pore dimension that is larger than conventional hydrotreating catalysts, i.e., VGO hydrotreating catalysts, with the relatively larger nominal average minimum pore dimension enabling the resid hydrotreating catalysts to effectively contact larger molecules than can be effectively contacted using conventional hydrotreating catalysts. Without being bound to a particular theory, it is believed that the resid hydrotreating catalyst is effective for saturating the HPNAs and HPNA precursors, which are generally larger molecules than other components in hydrocarbon streams that are subject to hydrocracking. After saturating the HPNAs and HPNA precursors, the saturated HPNAs and saturated HPNA precursors may then be cracked to avoid conversion back to HPNAs and HPNA precursors. Only after saturation of the HPNAs and HPNA precursors can they be cracked to smaller fragments. As a result, content of HPNAs and HPNA precursors may be reduced and buildup of HPNAs is avoided in any hydroprocessing recycle loop that may be employed, thereby avoiding the attendant impact of the HPNAs on hydroprocessing dynamics. The resid hydrotreating catalyst may be included in a downstream processing stage after an initial hydrocracking stage or in any hydroprocessing stage that receives a hydrocarbon stream that is depleted of metal-containing species. Whereas resid hydrotreating catalysts have conventionally been used for hydrodemetallization to simultaneously remove metal-containing species in a hydrocarbon stream during hydrocracking, as well as de-nitrogenation, de-sulfurization, and reduction of carbon residue (concarbon), the resid hydrotreating catalysts are conventionally included in the initial hydrocracking stage to remove most of the metal-containing species immediately and are not used for saturating HPNAs. Because HPNAs are produced during hydrocracking, resid hydrotreating catalyst included in the initial hydrocracking stage is less effective to saturate the HPNAs that are formed during hydrocracking whereas the resid hydrotreating catalyst in the downstream hydrocracking stage is effective to saturate the HNPAs and HPNA precursors. However, when a recycle loop is employed (with the recycle stream depleted of metal-containing species due to upstream hydroprocessing), the resid hydrotreating catalyst may be included in any stage that receives the recycle stream.

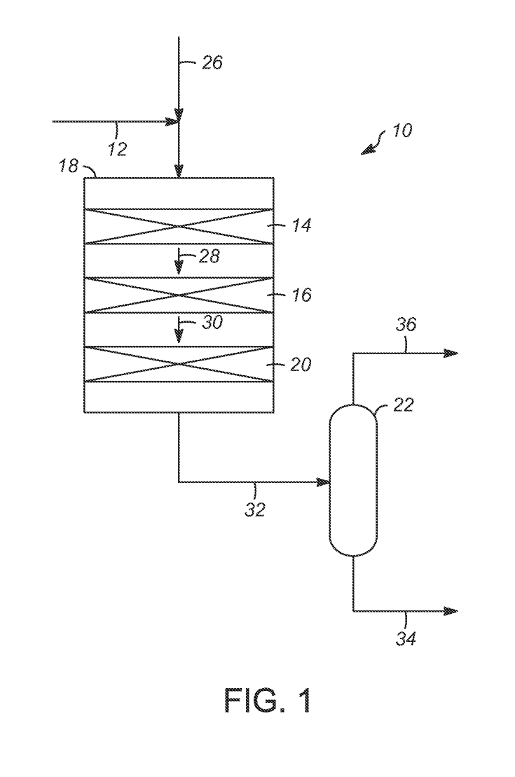

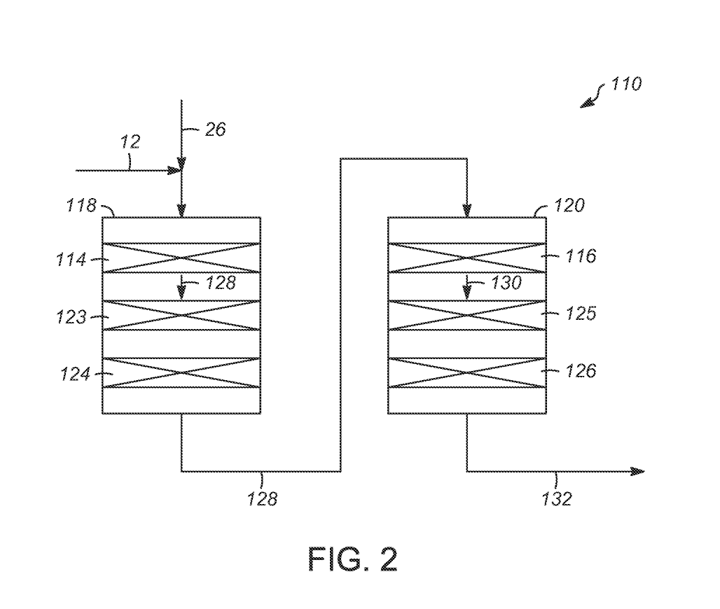

FIG. 1 is a schematic of an apparatus 10 for hydroprocessing a hydrocarbon stream 12 in accordance with an exemplary embodiment. Referring to FIG. 1, the exemplary apparatus 10 includes an initial hydrocracking bed 14 and a downstream bed 16, such as a downstream hydrocracking bed 16. However, in other embodiments, the downstream bed may be a hydrotreating bed and may be contained in a different reactor from the initial hydrocracking bed 14. The downstream bed 16, as referred to herein, may be immediately downstream of the initial hydrocracking bed 14, or may be separated from the initial hydrocracking bed 14 by other hydrocracking beds. Further, in the embodiment shown in FIG. 1, an additional hydrocracking bed 20 is included, although it is to be appreciated that multiple additional hydrocracking beds may be included per design and processing considerations. In an embodiment and as shown in FIG. 1, the initial hydrocracking bed 14 and the downstream hydrocracking bed 16 are contained within a single hydrocracking reactor 18. However, in other embodiments and referring momentarily to FIG. 2, an apparatus 110 for hydroprocessing the hydrocarbon stream 12 includes the initial hydrocracking bed 114 and the downstream hydrocracking bed 116 contained within different hydrocracking reactors 118, 120, with additional hydrocracking beds 123, 124, 125, 126 also included in the apparatus 110. In yet another embodiment and referring momentarily to FIG. 4, an apparatus 310 for hydroprocessing the hydrocarbon stream 12 includes the initial hydrocracking bed 314 and the downstream bed 316 in different reactors 318, 320, with the downstream bed 316 being a hydrotreating bed or another hydrocracking bed. Referring again to FIG. 1, a separator 22, such as a fractionation column, may be in fluid communication with the downstream bed 16. The separator 22 may further be in fluid communication with the downstream bed 16, the additional hydrocracking bed 20, and/or another hydrocracking bed of a different reactor (such as bed 126 shown in FIG. 2).

An exemplary method of hydroprocessing the hydrocarbon stream 12 will now be described with reference to the apparatus 10 shown in FIG. 1. The hydrocarbon stream 12 that may be subject to hydrocracking may be provided from any conventional source of hydrocarbons that are desirably hydrocracked. For example, the hydrocarbon stream 12 may be formed as a bottom stream from a vacuum fractionation zone (not shown). As used herein, “bottom stream” refers to a stream withdrawn at or near a bottom of a column, such as a distillation column An exemplary hydrocarbon stream 12 includes light cycle oil. Exemplary hydrocarbon streams also include gas oil, such as heavy gas oil or vacuum gas oil. As used herein, “light cycle oil” refers to a hydrocarbon material boiling in a range of from about 204° C. to about 343° C. and can include one or more C₁₃-C₁₈ hydrocarbons; “heavy gas oil” refers to a hydrocarbon material boiling in a range of from about 343° C. to about 524° C. and can include one or more C₁₆-C₂₅ hydrocarbons; and “vacuum gas oil” refers to a hydrocarbon material boiling in the range of from about 343° C. to about 524° C. and can include one or more C₂₂-C₄₅ hydrocarbons. In addition or as an alternative to light cycle oil or the gas oils, particular fresh feed components may include a wide variety of straight run and converted hydrocarbon fractions obtained in refinery operations (i.e., derived from crude oil), such as atmospheric gas oils, vacuum and deasphalted vacuum resids (e.g., boiling above 565° C.), atmospheric resids (e.g., boiling above about 343° C.), coker distillates, straight run distillates, whole or topped petroleum crude oils including heavy crude oils, pyrolysis-derived oils, high boiling synthetic oils, cycle oils and catalytic cracker (e.g., fluid catalytic cracking or FCC) distillates. Fresh feed components of the hydrocarbon stream 12 may also include mineral oils and synthetic oils (e.g., tars, bitumen, coal oils, shale oil, tar sand products, etc.) and fractions thereof. In embodiments, the hydrocarbon stream 12 includes metal-containing species that are removed during subsequent hydrocracking, as described in further detail below. In other embodiments, the hydrocarbon stream 12 is substantially free of metal-containing species, i.e., the hydrocarbon stream 12 may be provided with little or no detectable metal-containing species present therein.

Optionally, the hydrocarbon stream 12 may be hydrotreated prior to hydrocracking to remove, for example, sulfur and/or nitrogen compounds. Hydrotreating may be performed in a separate hydrotreating reactor (not shown) or in the same reactor as used for hydrocracking by incorporating, for example, a bed of hydrotreating catalyst (not shown) upstream of the initial hydrocracking bed 14. Suitable hydrotreating catalysts for use herein are any known conventional hydrotreating catalyst and include those that are comprised of at least one Group VIII metal (such as iron, cobalt and/or nickel) and at least one Group VI metal (such as molybdenum and/or tungsten) on a high surface area support material, preferably alumina. Other suitable hydrotreating catalysts include zeolitic catalysts, as well as noble metal catalysts where the noble metal is selected from palladium and platinum. It is within the scope herein that more than one type of hydrotreating catalyst be used in the same reaction vessel. The Group VIII metal may be present in an amount ranging from about 2 to about 20 weight percent, such as from about 4 to about 12 weight percent. The Group VI metal may be present in an amount ranging from about 1 to about 25 weight percent, such as from about 2 to about 25 weight percent.

The hydrocarbon stream 12 is hydrocracked in a first hydrocracking stage in the presence of a first hydrocracking catalyst to produce a first conversion stream 28. For example, the initial hydrocracking bed 14 may provide the first hydrocracking stage within which the hydrocarbon stream 12 is hydrocracked in the presence of the first hydrocracking catalyst to produce the first conversion stream 28. Hydrocracking is also generally conducted in the presence of hydrogen under conditions of elevated temperature and pressure so as to yield a product containing a distribution of hydrocarbon products desired by the refiner. The operating conditions and the hydrocracking catalysts within a hydrocracking reactor influence the yield of hydrocracked products. The hydrogen may be introduced directly into the first hydrocracking stage or a hydrogen stream 26 may be combined with the hydrocarbon stream 12. In embodiments, the first hydrocracking catalyst is a conventional hydrocracking catalyst and includes a non-noble Group VIII metal component and a Group VIB metal component, which may be deposited on a catalyst support. For purposes herein, the term “catalyst support” is defined as all materials in the first hydrocracking catalyst except the non-noble Group VIII metal component and the Group VIB metal component. The Group VIII metal component and a Group VIB metal component may be in the form of the free metals or their respective oxides and sulphides. Examples of suitable non-noble Group VIII metals that may be included in the Group VIII metal component include, e.g., nickel and cobalt. Examples of suitable Group VIB metals that may be included in the Group VIB metal component include molybdenum and tungsten. Specific examples of suitable conventional hydrocracking catalysts include nickel and molybdenum or nickel and tungsten in combination.

The non-noble Group VIII metal component and the Group VIB metal component may be incorporated into the first hydrocracking catalyst in any conventional manner. For example, the catalyst support may first be prepared as an extrudate containing zeolite beta or zeolite Y and an amorphous inorganic refractory oxide in calcined form. The catalyst support is then impregnated with solutions containing the desired metal(s) in dissolved form. Calcination in air, typically in the absence of added steam at an elevated temperature, e.g. above 425° C., such as above 475° C., produces the suitable first hydrocracking catalyst containing the desired metals in oxide form.

In embodiments, the hydrocarbon stream 12 contains metal-containing species, and the hydrocarbon stream 12 is depleted of the metal-containing species to produce a metal-depleted hydrocarbon stream. For example, the hydrocarbon stream 12 including metal-containing species may be hydrocracked in the first hydrocracking stage in the presence of a first stage resid hydrotreating catalyst, in addition to the first hydrocracking catalyst, to thereby hydrodemetallicize the hydrocarbon stream 12 and produce the first conversion stream 28 that is depleted of metal-containing species. In this embodiment, the first stage resid hydrotreating catalyst may be present in an amount of from about 0.5 to about 50% by volume, such as from about 2.5 to 20% by volume, based on the combined volume of the first hydrocracking catalyst and the first stage resid hydrotreating catalyst. In other embodiments and although not shown, the hydrocarbon stream 12 may be depleted of metal-containing species prior to hydrocracking in the first hydrocracking stage, with the hydrocarbon stream 12 thus being substantially free of detectable metal-containing species.

The first stage resid hydrotreating catalyst may be chemically indistinguishable from the hydrotreating catalyst, but with the first stage resid hydrotreating catalyst having a larger nominal average minimum pore dimension than the first hydrotreating catalyst. For example, in embodiments, the first stage resid hydrotreating catalyst has a nominal average minimum pore dimension of at least 120 Å, such as from about 150 Å to about 500 Å, as measured using mercury porosimetry. Resid hydrotreating catalysts also generally have a lower average bed density than conventional hydrotreating catalysts. For example, typical average bed density of resid hydrotreating catalysts is less than about 700 kg/m³.

In an exemplary embodiment, the hydrocracking reaction conditions in the first hydrocracking stage include a temperature of from about 205° C. to about 480° C. and a pressure from about 3.5 megapascals (MPa) to about 20.8 MPa. In addition, hydrocracking conditions may include a liquid hourly space velocity from about 0.1 to about 30 hr⁻¹.

The hydrocracking products in the first conversion stream 28 have a lower boiling temperature than the hydrocarbon stream 12, and typically have boiling temperatures of from about 150° C. to about 370° C. Due to the presence of the first stage resid hydrotreating catalyst, the first conversion stream 28 is depleted of metal-containing species and, thus, is substantially free of the metal-containing species. For example, in embodiments, the first conversion stream 28 has less than about 3 ppm by weight of metal-containing species based on the total weight of the first conversion stream 28. However, the first conversion stream 28 includes polynuclear aromatic compounds, such as HPNAs. In embodiments, the polynuclear aromatic compounds are present in the first conversion stream 28 in amounts on an order of ppms.

In accordance with the exemplary method, components from the first conversion stream 28 are treated in a downstream processing stage in the presence of a downstream resid hydrotreating catalyst to produce a second conversion stream 30. For example, the downstream bed 16 may provide the downstream processing stage within which the first conversion stream 28 is treated in the presence of the downstream resid hydrotreating catalyst to produce the second conversion stream 30. Alternatively, the downstream bed that includes the downstream resid hydrotreating catalyst may be hydrocracking bed 20, with hydrocracking bed 16 disposed between the initial hydrocracking bed 14 and the hydrocracking bed 20. In this embodiment, the first conversion stream 28 is not directly hydrocracked in the hydrocracking bed 20, but components from the first conversion stream 28 are cracked in the hydrocracking bed 20. Additionally, it is to be appreciated that each post-initial hydrocracking bed 16, 20 may include the downstream resid hydrotreating catalyst to enable saturation of polynuclear aromatic compounds that are produced in each hydrocracking bed 14, 16, 20 of the apparatus 10. However, it is to be appreciated that much of the polynuclear aromatic compounds that are produced by hydrocracking the hydrocarbon stream 12 are produced in the initial hydrocracking bed 14 such that inclusion of the downstream resid hydrotreating catalyst in hydrocracking bed 16 may maximize saturation of polynuclear aromatic compounds while avoiding detrimental impact of polynuclear aromatic compounds on structures and materials within the apparatus 10.

The downstream resid hydrotreating catalyst may be the same as or different from the first stage resid hydrotreating catalyst described above, but is subject to the same nominal average minimum pore dimension ranges as set forth above for the first stage resid hydrotreating catalyst. The presence of the downstream resid hydrotreating catalyst in the downstream processing stage, or at least at a stage downstream of metal depletion of the hydrocarbon stream 12, enables effective saturation of polynuclear aromatic compounds, such as HPNAs, that are produced in the first hydrocracking stage and included in the first conversion stream 28, and the saturated polynuclear aromatic compounds may then be cracked into smaller fragments.

While the components from the first conversion stream 28 are treated in the downstream processing stage in the presence of the downstream resid hydrotreating catalyst, the components from the first conversion stream 28 may also be hydrocracked in the presence of the first hydrocracking catalyst in the downstream processing stage. In this regard, a combination of the first hydrocracking catalyst and the downstream resid hydrotreating catalyst may be employed in the downstream processing stage, and the downstream processing stage may be a second hydrocracking stage. In embodiments, the downstream resid hydrotreating catalyst is present in the downstream processing stage in an amount of at least about 5 weight %, such as from about 2 to about 20 weight %, based on the total weight of catalyst in the downstream processing stage. Additionally, a small amount of conventional hydrotreating catalyst may also be present in the downstream processing stage and employed as a post-treat catalyst to treat traces of sulfur containing mercaptans that are formed during hydrocracking. A balance of catalyst in the downstream processing stage may be the first hydrocracking catalyst.

After treating, a hydrocracked stream 32 is produced that includes components from the second conversion stream 30. In embodiments, the hydrocracked stream 32 may be the second conversion stream 30 or, alternatively, the second conversion stream 30 may be subject to further hydrocracking and/or hydrotreating to produce the hydrocracked stream 32 that includes components from the second conversion stream 30, in addition to components resulting from the further hydrocracking.

Further processing of the hydrocracked stream 32 may by conducted after hydrocracking, including fractionation, denitrification, desulfurization, stripping and washing to form product streams such as naphtha, kerosene, and/or diesel streams and to recover vacuum gas oil. In an embodiment and referring to FIG. 1, a recycle stream 34 is separated that includes components from the second conversion stream 30. In particular, the recycle stream 34 may be produced by the separator 22, which receives the hydrocracked stream 32 that includes components from the second conversion stream 30, and the separator 22 produces the recycle stream 34 that includes components from the second conversion stream 30 and a product stream 36 that includes cracked hydrocarbons. For example, uncracked hydrocarbons and HPNAs may be separated into the recycle stream 34 for further saturation and hydrocracking.

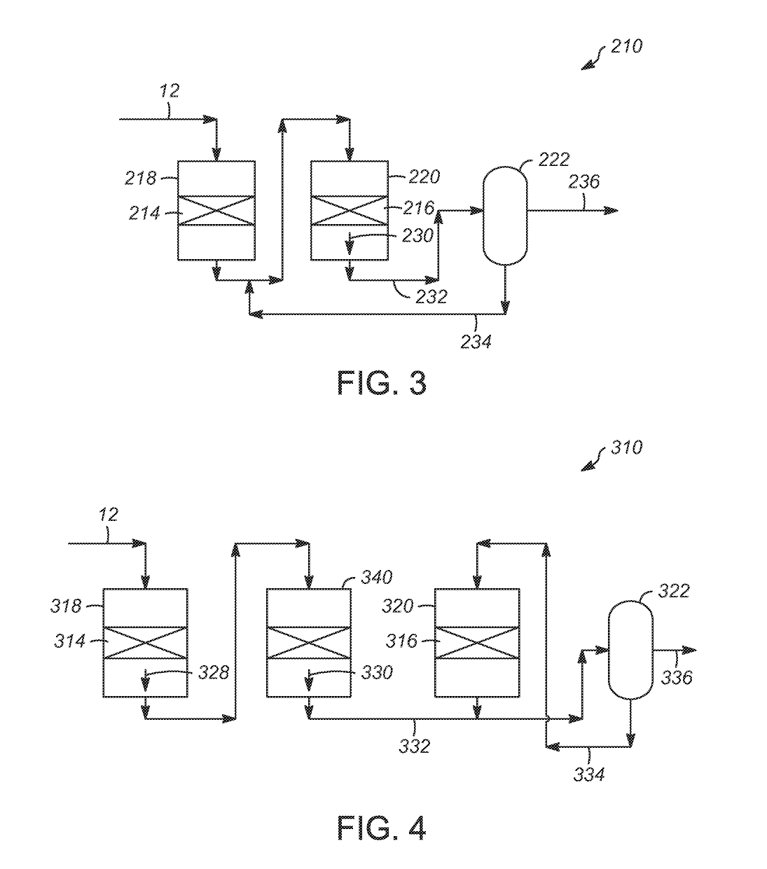

In an embodiment, the recycle stream 34 is hydrocracked in the presence of resid hydrotreating catalyst, which may be the same or different from the first stage resid hydrotreating catalyst and/or the downstream resid hydrotreating catalyst described above. In embodiments, the separator 22 is further in fluid communication with the downstream hydrocracking bed 16 and/or a different hydrocracking bed that includes resid hydrotreating catalyst for providing the recycle stream 34 for hydrocracking, examples of which are described in further detail below in the context of FIGS. 3 and 4. In embodiments, the recycle stream 34 may be provided to any hydrocracking bed that is adapted to hydrocrack the hydrocarbon stream 12 that has been depleted of or is otherwise substantially free of metal-containing species, with the hydrocracking bed including resid hydrotreating catalyst. For example, the recycle stream 34 may be provided to hydrocracking bed 16 or hydrocracking bed 20 for hydrocracking in the presence of the downstream resid hydrotreating catalyst, or may be provided to hydrocracking bed 14 under conditions in which the hydrocarbon stream has been depleted of or is otherwise substantially free of metal-containing species.

In another embodiment and referring to FIG. 2, another exemplary method of hydroprocessing the hydrocarbon stream 12 in another apparatus 110 is shown. In this embodiment, hydrocracking beds are arranged in separate and distinct hydrocracking reactors 118, 120, with one hydrocracking reactor 118 containing the initial hydrocracking bed 114 as described above and with another hydrocracking reactor 120 containing the downstream bed 116 as described above that contains the downstream resid hydrotreating catalyst. In this embodiment, additional hydrocracking beds 123, 124, 125, 126 are also included in the apparatus 110 to illustrate that the apparatus 110 may be configured to saturate the polynuclear aromatic compounds in the separate hydrocracking reactor 120. However, components from the first conversion stream 128 are still treated in the downstream bed 116 in the presence of the downstream resid hydrotreating catalyst to produce the second conversion stream 130, with the hydrocracked stream 132 produced by the additional hydrocracking reactor 120.

In another embodiment and referring to FIG. 3, another exemplary method of hydroprocessing the hydrocarbon stream 12 is shown in another apparatus 210 that provides a recycle loop. In this embodiment, hydrocracking beds are arranged in a similar manner as described above in the embodiment of FIG. 2, with separate and distinct hydrocracking reactors 218, 220, and with hydrocracking reactor 218 containing the initial hydrocracking bed 214 as described above and with hydrocracking reactor 220 containing the downstream bed 216 as described above that contains the downstream resid hydrotreating catalyst. Recycle stream 234 may be produced by separator 222, which receives hydrocracked stream 232 that includes components from the second conversion stream 230, and the separator 22 produces the recycle stream 234 that includes components from the second conversion stream 230 and a product stream 236 that includes cracked hydrocarbons. In this embodiment, the recycle stream 234 is provided to the second hydrocracking stage, namely, the downstream hydrocracking bed 216 that is disposed in hydrocracking reactor 220 for hydrocracking independent of the hydrocarbon stream 12

In another embodiment and referring to FIG. 4, another exemplary method of hydroprocessing the hydrocarbon stream 12 is shown in another apparatus 310 that provides a recycle loop. In this embodiment, hydrocracking beds are arranged in a similar manner as described above in the embodiment of FIG. 2, with separate and distinct hydrocracking reactors 318, 340, and with hydrocracking reactor 218 containing the initial hydrocracking bed 214 as described above. However, in this embodiment, reactor 320 contains the downstream bed 316 as described above that contains the downstream resid hydrotreating catalyst. The reactor 320 may be a hydrotreating reactor that includes the downstream resid hydrotreating catalyst or may be another hydrocracking reactor that contains hydrocracking catalyst, in addition to the downstream resid hydrotreating catalyst. Recycle stream 334 may be produced by separator 322, which receives hydrocracked stream 332 that includes components from the second conversion stream 330, and the separator 322 produces the recycle stream 334 that includes components from the second conversion stream 330 and a product stream 336 that includes cracked hydrocarbons. In this embodiment, the recycle stream 334 is provided to the hydrotreating stage, namely, the downstream bed 316 that is disposed in reactor 320 for treatment independent of the hydrocarbon stream 12, first conversion stream 328, or second conversion stream 230.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of hydroprocessing a hydrocarbon stream, wherein the method comprises the steps of:
hydrocracking the hydrocarbon stream in a first hydrocracking stage in the presence of a first hydrocracking catalyst to produce a first conversion stream; and
treating components from the first conversion stream in a downstream processing stage in the presence of a downstream resid hydrotreating catalyst to produce a second conversion stream.

2. The method of claim 1, wherein the downstream processing stage comprises a hydrotreating stage, and wherein treating the components from the first conversion stream comprises hydrotreating components from the first conversion stream in the hydrotreating stage in the presence of the downstream resid hydrotreating catalyst to produce the second conversion stream.

3. The method of claim 1, wherein treating the components from the first conversion stream comprises treating the components from the first conversion stream depleted of metal-containing species.

4. The method of claim 3, wherein treating the first conversion stream depleted of metal-containing species comprises treating the first conversion stream having less than about 3 ppm by weight of metal-containing species based on the total weight of the first conversion stream.

5. The method of claim 1, wherein the first conversion stream comprises polynuclear aromatic compounds, and wherein treating the components from the first conversion stream comprises saturating the polynuclear aromatic compounds from the first conversion stream in the downstream processing stage in the presence of the downstream resid hydrotreating catalyst.

6. The method of claim 1, wherein the downstream processing stage comprises a second hydrocracking stage, and wherein treating the components from the first conversion stream comprises hydrotreating components from the first conversion stream in the second hydrocracking stage in the presence of the downstream resid hydrotreating catalyst to produce the second conversion stream.

7. The method of claim 6, wherein treating the components from the first conversion stream in the downstream processing stage further comprises hydrocracking the components from the first conversion stream in the presence of the first hydrocracking catalyst in the second hydrocracking stage.

8. The method of claim 1, wherein hydrocracking the hydrocarbon stream comprises hydrocracking the hydrocarbon stream comprising gas oil.

9. The method of claim 1, wherein hydrocracking the hydrocarbon stream in the first hydrocracking stage comprises hydrocracking the hydrocarbon stream comprising metal-containing species in the first hydrocracking stage.

10. The method of claim 9, wherein hydrocracking the hydrocarbon stream comprises hydrocracking the hydrocarbon stream in the first hydrocracking stage in the presence of a first stage resid hydrotreating catalyst.

11. The method of claim 1, wherein treating the components from the first conversion stream comprises hydrotreating the components from the first conversion stream in the presence of the downstream resid hydrotreating catalyst having a nominal average minimum pore dimension of at least 120 Å.

12. The method of claim 1, further comprising separating a recycle stream comprising components from the second conversion stream.

13. The method of claim 12, further comprising hydrotreating the recycle stream in the presence of resid hydrotreating catalyst.

14. A method of hydroprocessing a hydrocarbon stream, wherein the method comprises the steps of:
providing the hydrocarbon stream substantially free of metal-containing species; and
treating the hydrocarbon stream in a processing stage in the presence of a resid hydrotreating catalyst to produce a conversion stream.

15. An apparatus for hydroprocessing a hydrocarbon stream, wherein the apparatus comprises:
an initial hydrocracking bed comprising a first hydrocracking catalyst for hydrocracking the hydrocarbon stream to produce a first conversion stream; and
a downstream bed comprising a downstream resid hydrotreating catalyst for treating the components from the first conversion stream to produce a second conversion stream.

16. The apparatus of claim 15, wherein the initial hydrocracking bed and the downstream bed are contained within a single hydrocracking reactor.

17. The apparatus of claim 15, wherein the initial hydrocracking bed and the downstream bed are contained within different hydrocracking reactors.

18. The apparatus of claim 15, wherein the initial hydrocracking bed further comprises a first stage resid hydrotreating catalyst.

19. The apparatus of claim 15, further comprising a separator in fluid communication with one of the initial hydrocracking bed or the downstream bed for producing a recycle stream.

20. The apparatus of claim 19, wherein the separator is further in fluid communication with the downstream bed and/or a different bed comprising resid hydrotreating catalyst.
